(19) United States
(12) Patent Application Publication
(10) Pub. No.: US 2017/0273507 A1
(43) Pub. Date: Sep. 28, 2017

(54) COOKWARE COVER

(71) Applicant: Gloria Osorio, Linden, VA (US)

(72) Inventor: Gloria Osorio, Linden, VA (US)

(21) Appl. No.: 15/466,515

(22) Filed: Mar. 22, 2017

Related U.S. Application Data
(60) Provisional application No. 62/311,708, filed on Mar. 22, 2016.

(51) Int. Cl. A47J 39/02; B65D 33/25; B65D 33/24; B65D 81/38

(52) U.S. Cl. CPC A47J 39/02; B65D 81/3876; B65D 33/25; B65D 33/24

(57) ABSTRACT

A cookware cover includes a base portion and two opposing flaps connected thereto. A first fastener, such as a zipper, has its complementary parts attached to the flaps, such that, when the flaps are folded over the top of the base portion, the flaps can be secured to each other. Additional fasteners, such as hook-and-loop fasteners, can have their complementary parts attached to the flaps and the base portion, respectively, so that the flaps can also be secured to the base portion in order to seal a piece of cookware within the cover. The cookware cover can include and/or be constructed from a thermally-insulative material.

### CROSS-REFERENCE TO RELATED APPLICATIONS

This application claims the benefit of U.S. provisional application No. 62/311,708, filed 22 Mar. 2016, which is hereby incorporated by reference as though fully set forth herein.

### BACKGROUND

The instant disclosure relates to cookware covers. In particular, the instant disclosure relates to an insulated cookware cover that can be used to transport large cookware and to keep the contents thereof warm.

### BRIEF SUMMARY

Disclosed herein is a cookware cover, including: a base portion having a first edge and a second edge opposite the first edge; a first flap having a first edge and a second edge, the first edge of the first flap being connected to the first edge of the base portion; a second flap having a first edge and a second edge, the second edge of the second flap being connected to the second edge of the base portion; a first fastener including first and second complementary parts, the first complementary part of the first fastener being attached to the first flap and the second complementary part of the first fastener being attached to the second flap; and a second fastener including first and second complementary parts, the first complementary part of the second fastener being attached to the base portion and the second complementary part of the second fastener being attached to at least one of the first flap and the second flap. The second complementary part of the second fastener can include a first sub-part attached to the first flap and a second sub-part attached to the second flap.

Optionally, the cookware cover also includes a third fastener having first and second complementary parts, the first complementary part of the third fastener being attached to the base portion and the second complementary part of the third fastener being attached to at least one of the first flap and the second flap. The second complementary part of the third fastener can include a first sub-part attached to the first flap and a second sub-part attached to the second flap. In embodiments, the third fastener is a hook and loop fastener.

It is contemplated that the second fastener can be a hook and loop fastener.

It is also contemplated that the first fastener can include a zipper.

According to aspects of the disclosure, the first complementary part of the first fastener is attached to the first flap adjacent the second edge of the first flap, and the second complementary part of the first fastener is attached to the second flap adjacent the first edge of the second flap.

The base portion, the first flap, and the second flap can include a thermal insulator and/or be made of a thermally-insulating material.

The base portion, the first flap, and the second flap can be integrally formed or formed from separate pieces and joined together (e.g., by sewing).

Also disclosed herein is a cookware cover including: a first flap; a second flap joined to the first flap and foldable relative to the first flap, such that the cookware cover has an open configuration to receive a cookware and a closed configuration to enclose the cookware; and at least one fastener positioned along a perimeter of the cookware cover to secure the cookware cover in the closed configuration, the at least one fastener comprising first and second complementary parts, the first complementary part being attached to the first flap and the second complementary part being attached to the second flap. In embodiments, the at least one fastener includes a plurality of fasteners. The fasteners can be selected from the group consisting of hook-and-loop fasteners, snaps, buttons, clips, and zippers.

According to aspects of the disclosure, the perimeter of the cookware cover in the closed configuration is circular. The perimeter of the cookware cover in the closed configuration can also include at least one opening dimensioned to accommodate therethrough at least one handle of the cookware received therein.

The first flap and the second flap of the cookware cover can be made out of, lined with, or otherwise include a thermal insulator, such as metallized polyethylene terephthalate.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a top plan view of a cookware cover according to embodiments disclosed herein.

FIGS. 2a-2c are a series of views that depict use of the cookware cover of FIG. 1.

FIG. 3 is a top plan view of a cookware cover according to another embodiment disclosed herein.

### DETAILED DESCRIPTION

The present disclosure provides an insulated cover for cookware. For purposes of illustration, certain embodiments will be described herein in the context of a cover for a paella pan, which is a large diameter but relatively shallow pan. It should be understood, however, that the teachings herein can be applied to good advantage in other contexts.

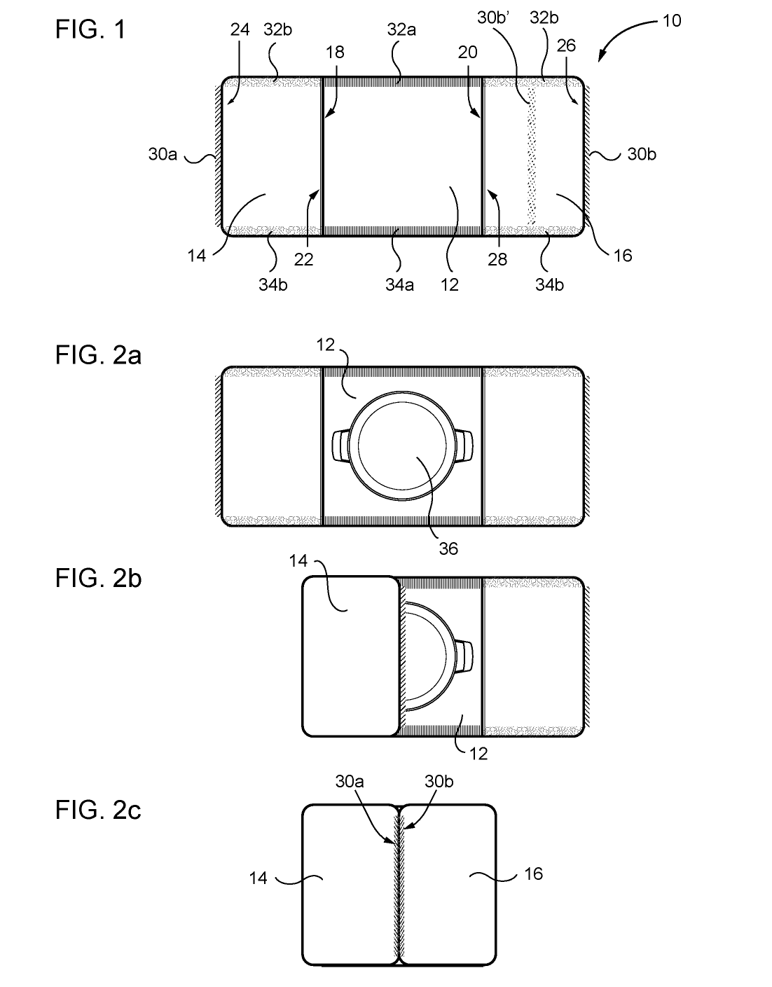

FIG. 1 is a top plan view of an embodiment of a cookware cover 10 according to aspects of the instant disclosure. Cookware cover 10 generally includes a base portion 12, a first flap 14, and a second flap 16, which can be made out of, lined with, and/or include a thermally insulating material, such as the material used in the manufacture of space blankets (e.g., metallized polyethylene terephthalate). In embodiments, base portion 12 can be thicker than first flap 14 and/or second flap 16, in order to provide additional thermal insulation adjacent the bottom of the cookware that is being covered, for example to protect the surface upon which cookware cover 10 is placed from heat damage.

Base portion 12 includes a first edge 18 and a second edge 20 opposite first edge 18.

First flap 14 includes a first edge 22 and a second edge 24. First flap 14 is attached to base portion 12 along their respective first edges 22, 18.

Second flap 16 includes a first edge 26 and a second edge 28. Second flap 16 is attached to base portion 12 along their respective second edges 28, 20.

In some aspects of the disclosure, base portion 12, first flap 14, and second flap 16 are integrally formed, such as from a single, continuous sheet of material. It is also contemplated, however, to form one or more of base portion 12, first flap 14, and second flap 16 as separate pieces and then join them to each other, for example by sewing them together along their edges as described above.

Cookware cover 10 also includes a first fastener, such as a zipper or hook-and-loop fastener, that includes first and second complementary or mating parts. As shown in FIG. 1, the first complementary part 30a of the first fastener is attached to first flap 14, while the second complementary part 30b of the first fastener is attached to second flap 16.

In embodiments, first complementary part 30a of the first fastener can be attached to first flap 14 adjacent second edge 24 thereof. Similarly, second complementary part 30b of the first fastener can be attached to second flap 16 adjacent first edge 26 thereof. Other configurations are within the scope of this disclosure, however. For example, a second complementary part 30b′ of the first fastener could be attached closer to the middle of second flap 16 on the reverse side thereof (shown in phantom in FIG. 1), which would facilitate a tighter fit of cookware cover 10 to cookware therein. It is also contemplated that second flap 16 could include both second complementary part 30b and second complementary part 30b′, which would allow a user to choose the final size of cookware cover 10 when closed around cookware.

Cookware cover 10 also includes a second fastener, such as a hook-and-loop fastener, that includes first and second complementary or mating parts. The first complementary part 32a of the second fastener is attached to base portion 12, while the second complementary part 32b of the second fastener is attached to at least one of first flap 14 and second flap 16. In embodiments, the second complementary part 32b of the second fastener is divided into first and second sub-parts, each of which is attached to one of first flap 14 and second flap 16.

According to aspects of the disclosure, cookware cover 10 also includes a third fastener, such as a hook-and-loop fastener, that includes first and second complementary or mating parts. The first complementary part 34a of the second fastener is attached to base portion 12, while the second complementary part 34b of the second fastener is attached to at least one of first flap 14 and second flap 16. In embodiments, the second complementary part 34b of the second fastener is divided into first and second sub-parts, each of which is attached to one of first flap 14 and second flap 16.

FIGS. 2a-2c illustrate use of cookware cover 10 to cover a paella pan 36. As shown in FIG. 2a, paella pan 36 is placed on base portion 12. As shown in FIG. 2b, first flap 14 is then folded over the top of paella pan 36. Finally, in FIG. 2c, second flap 16 is folded over the top of paella pan 36. Cookware cover 10 can then be sealed by securing the first complementary parts 30a, 32a, 34a of the first, second, and third fasteners, respectively, to their respective second complementary parts 30b, 32b, 34b. Cookware cover 10 will now retain heat within paella pan 36, while remaining loose enough about paella pan 36 to allow one to lift it using the handles on paella pan 36. Alternatively or additionally, handles could be provided on the exterior of cookware cover 10 (e.g., at or near the seams where first and second flaps 14, 16 meet base portion 12).

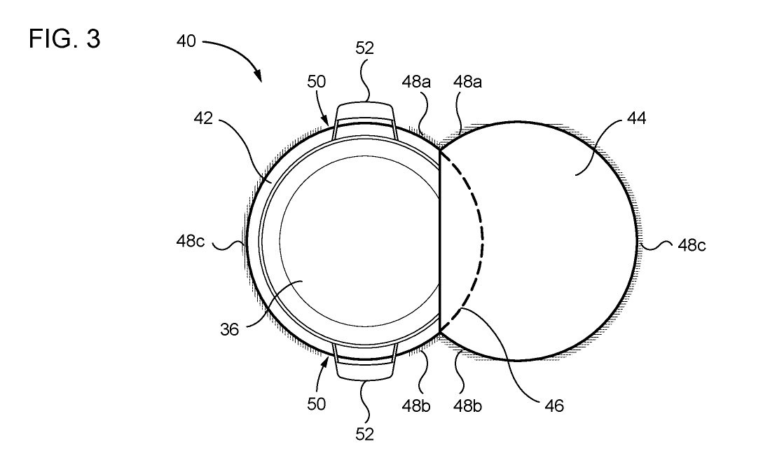

Another embodiment of a cookware cover 40 is illustrated in FIG. 3. Cookware cover 40 generally includes a lower panel 42 and an upper panel 44. Lower panel 42 and upper panel 44 are connected, for example along seam 46 (shown in phantom in FIG. 3), so that they can be folded open into the configuration shown in FIG. 3 in order to receive paella pan 36.

As shown in FIG. 3, cookware cover 40 is generally circular in shape to conform to the shape of paella pan 36. Seam 46 extends about a portion of the circumference of cookware cover 40. It should be understood that the circumferential extent of seam 46 shown in FIG. 3 is merely illustrative and that it can extend around more or less of the circumference of cookware cover 40 without departing from the scope of the instant teachings.

FIG. 3 also illustrates a plurality of fasteners 48a, 48b, and 48c extending around an additional portion of the circumference of cookware cover 40. Fasteners 48a, 48b, and 48c are operable to secure lower panel 42 and upper panel 44 in a closed configuration, analogous to that shown in FIG. 2c.

Various types of fasteners 48a, 48b, and 48c are regarded as within the scope of the instant disclosure. For example, in some aspects of the disclosure, fasteners 48a, 48b, and 48c are all hook-and-loop fasteners. In other aspects of the disclosure, fasteners 48a, 48b, and 48c are all zippers. In still other aspects of the disclosure, fasteners 48a, 48b, and 48c are all clips, buttons, and/or snaps.

It is also contemplated that a combination of various types of fasteners could be used. For example, fasteners 48a and 48b can be hook-and-loop fasteners, while fastener 48c can be a zipper.

In embodiments of the disclosure, fasteners 48a, 48b, and 48c do not extend about the entire remaining circumference of cookware cover 40 (e.g., other than seam 46). In particular, it is desirable to leave openings 50 in the circumference of cookware cover 40. This permits handles 52 of paella pan 36 to protrude from cookware cover 40 in order to carry cookware cover 40 with paella pan 36 therein. Of course, embodiments where openings 50 can also be sealed, such as by extending fasteners 48a, 48b until they abut fastener 48c, are also contemplated.

Although several embodiments of this invention have been described above with a certain degree of particularity, those skilled in the art could make numerous alterations to the disclosed embodiments without departing from the spirit or scope of this invention.

For example, although the first fastener is depicted and described as a zipper, it could also be one or more snaps, clips, or a hook-and-loop fastener.

As another example, cookware cover 10 can be formed in a variety of sizes to accommodate a variety of sizes of cookware.

As yet another example, although cookware cover 40 is depicted as formed from two separate panels 42, 44 joined along a seam 46, cookware cover 40 could also be formed from a single sheet of material that, when unfolded into an open configuration to receive paella pan 36, generally resembles a figure-eight.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A cookware cover comprising:
a base portion having a first edge and a second edge opposite the first edge;
a first flap having a first edge and a second edge, the first edge of the first flap being connected to the first edge of the base portion;
a second flap having a first edge and a second edge, the second edge of the second flap being connected to the second edge of the base portion;
a first fastener comprising first and second complementary parts, the first complementary part of the first fastener being attached to the first flap and the second complementary part of the first fastener being attached to the second flap; and
a second fastener comprising first and second complementary parts, the first complementary part of the second fastener being attached to the base portion and the second complementary part of the second fastener being attached to at least one of the first flap and the second flap.

2. The cookware cover according to claim 1, wherein the second complementary part of the second fastener comprises a first sub-part attached to the first flap and a second sub-part attached to the second flap.

3. The cookware cover according to claim 1, further comprising a third fastener comprising first and second complementary parts, the first complementary part of the third fastener being attached to the base portion and the second complementary part of the third fastener being attached to at least one of the first flap and the second flap.

4. The cookware cover according to claim 3, wherein the second complementary part of the third fastener comprises a first sub-part attached to the first flap and a second sub-part attached to the second flap.

5. The cookware cover according to claim 3, wherein the third fastener comprises a hook and loop fastener.

6. The cookware cover according to claim 1, wherein the second fastener comprises a hook and loop fastener.

7. The cookware cover according to claim 1, wherein the first fastener comprises a zipper.

8. The cookware cover according to claim 1, wherein the first complementary part of the first fastener is attached to the first flap adjacent the second edge of the first flap.

9. The cookware cover according to claim 8, wherein the second complementary part of the first fastener is attached to the second flap adjacent the first edge of the second flap.

10. The cookware cover according to claim 1, wherein the base portion, the first flap, and the second flap comprise a thermal insulator.

11. The cookware cover according to claim 1, wherein the base portion, the first flap, and the second flap are integrally formed.

12. A cookware cover comprising:
a first flap;
a second flap joined to the first flap and foldable relative to the first flap, such that the cookware cover has an open configuration to receive a cookware and a closed configuration to enclose the cookware; and
at least one fastener positioned along a perimeter of the cookware cover to secure the cookware cover in the closed configuration, the at least one fastener comprising first and second complementary parts, the first complementary part being attached to the first flap and the second complementary part being attached to the second flap.

13. The cookware cover according to claim 12, wherein the at least one fastener comprises a plurality of fasteners.

14. The cookware cover according to claim 12, wherein the at least one fastener is selected from the group consisting of hook-and-loop fasteners, snaps, buttons, clips, and zippers.

15. The cookware cover according to claim 12, wherein the perimeter of the cookware cover in the closed configuration is circular.

16. The cookware cover according to claim 12, wherein the perimeter of the cookware cover in the closed configuration includes at least one opening, wherein the at least one opening is dimensioned to accommodate therethrough at least one handle of the cookware received therein.

17. The cookware cover according to claim 12, wherein the first flap and the second flap comprise a thermal insulator.

18. The cookware cover according to claim 17, wherein the thermal insulator comprises metallized polyethylene terephthalate.
